(19) United States
(12) Patent Application Publication
(10) Pub. No.: US 2004/0116838 A1
(43) Pub. Date: Jun. 17, 2004

(54) Method of normalizing soft tissue

(76) Inventor: Brian A. Polvi, Monument, CO (US)

Correspondence Address: G. F. Gallinger, 7420 Milner Dr., Colorado Springs, CO, 80920, US

(21) Appl. No.: 10/319,882

(22) Filed: Dec. 16, 2002

(51) Int. Cl. A61H 7/00

(52) U.S. Cl. 601/1; 601/138

(57) ABSTRACT

A dynamic method of breaking up fibrous adhesions or scar tissue in muscles is disclosed. The dynamic method results in the fibers replacing the scar tissue oriented longitudinally with respect to stress in the muscle, so that the muscle heals having improved function—flexibility, coordination and tensile strength. The method of comprises the steps of: locating fibrous adhesions in the muscle; and, applying and slidingly moving pressure along the length of the muscle over the fibrous adhesions therein to break down those adhesions. In a preferred aspect of this method the sliding movement along the length of the muscle coincides with body motion moving the muscle from a contracted to an elongated position so that the muscle is massaged in a repetitive cycle of body motion. If the step of injecting an anesthetic into the adhesions prior to massage is included then adhesion breakdown is promoted, and pain associated with adhesion breakdown is relieved.

### FIELD OF THE INVENTION

This invention relates to problems arising after an injury or trauma which produced fibrous adhesions in muscle, tendons, or other soft tissue. More particularly this invention relates to a dynamic method of breaking up fibrous adhesions or scar tissue. The disclosed treatment has resulted in discontinuance of pain and improved functionality—full mobility, strength and flexibility—to many patients who suffered for years after having tried everything else unsuccessfully.

### BACKGROUND OF THE INVENTION

An acute injury or a repetitive trauma typically results in tears or separations in soft tissue. The body repairs itself by producing fibrous adhesions to bridge these separations. The fibrous adhesions are accompanied by dense capillary concentration in adjacent tissues. These capillary matrixes are formed to supply oxygen and nutrients for repair of the injured area.

In the absence of full motion soft tissues heal with an inferior grade of tissue. Stress and movement help the cells to line up along the normal directions of stress as the tissue heals. Because tissue heals by proliferation neighboring fibroblasts, scar tissue is the normal result. Poor healing leads to altered biomechanics that result in aberrant reflexes, and pain. Scar tissues and abnormal excessive capillarization within any body muscle can result in the phenomena of super sensitivity as a result of the excess proliferation of nerve fibers around the region of the scar. When scar tissue is formed in the back, areas adjacent to the restricted scar tissue may become hypermobile due to a compensatory reaction which can result in degenerative changes of spinal discs and facets.

Optimal body performance requires that the fibrous adhesions be broken down, and replaced with collagen fibers oriented longitudinally with respect to the muscle or other soft tissue. What optimal performance requires is a method which breaks down the adhesion and additionally longitudinally stresses the muscle or other soft tissue so that collagen fibers replacing the fibrous adhesion will be oriented longitudinally with respect to the muscle or other soft tissue thereby producing tensile strength in the required direction.

### OBJECTS OF THE INVENTION

It is an object of this invention to disclose a method of removing pathology and accompanying excess vascularisation from soft tissue. It is an object of this invention to disclose a method which has been substantially more effective in restoring strength and performance, relieving abnormal sensitivity, and stopping recurring pain associated with a muscle injury than all other methods and treatments tried by numerous patients. It is yet a further object of this invention to disclose a method which not only removes pathology, but additionally orients the fibers replacing the pathology to correctly orient themselves longitudinally with respect to stress in the muscle, so that the muscle heals having improved tensile strength along its length.

One aspect of this invention provides for a method of normalizing an elongate traumatized tissue having fibrous adhesions therein comprising the steps of: locating the fibrous adhesions in the traumatized tissue; applying pressure on the traumatized tissue; and, moving the pressure along the length of the traumatized tissue over the fibrous adhesions therein to break down those adhesions.

In a preferred aspect of this method the adhesions are in a muscle and a sliding movement along the length of the muscle coincides with body motion moving the muscle from a contracted to an elongated position so that the muscle is massaged in a repetitive cycle of body motion.

It is most preferable to further include the step of injecting an anesthetic into the adhesions to promote, and relieve pain associated with adhesion breakdown.

Various other objects, advantages and features of this invention will become apparent to those skilled in the art from the following description in conjunction with the accompanying drawings.

### FIGURES OF THE INVENTION

FIG. 1 is a perspective view of a patient lying in a prone position having adhesions in muscles on the back portion of the upper leg, the upper back, and the left side of the lower neck marked for treatment.

FIG. 2 is a partial elevational view of the right leg shown in FIG. 1 wherein the treated muscle is in a contracted position. Movement of pressure along the length of the treated muscle is just beginning.

FIG. 3 is a partial elevational view of the right leg shown in FIG. 1 wherein the treated muscle is in an intermediate position. Movement of the pressure along the treated muscle is also in an intermediate position.

FIG. 4 is a is a partial elevational view of the right leg shown in FIG. 1 wherein the treated muscle is in a fully elongated or stretched position. Movement of the pressure along the treated muscle has reached the end of the muscle.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

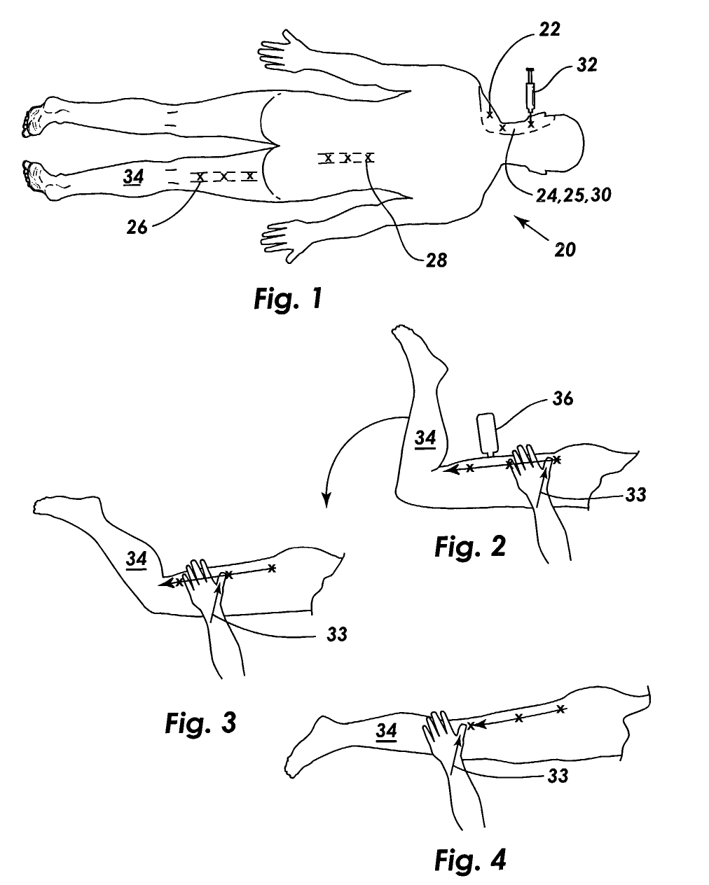

Turning now to the drawings and more particularly to FIG. 1 we have a perspective view of a patient lying in a prone position having adhesions in muscles 24 on the back portion of the upper leg 26, the lower back 28, and the left side of the lower neck 30 marked x for treatment. Most generally, the method of normalizing an elongate traumatized soft tissue 25 having pathology 22 therein comprising the steps of: locating the pathology 22 in the traumatized tissue 25; applying pressure on the traumatized tissue 25; and, moving the pressure along the length of the traumatized tissue 25 over the fibrous adhesions 22 therein to break down those adhesions 22.

Most preferably, after the fibrous adhesions are located through indications of sensitivity from the patient and feeling for points of inflexibility in and along the muscles 24, the adhesions 22 are first marked X, and then injected 32 with an anesthetic. The anesthetic both promotes the breakdown of the adhesions 22 during massage, and relieves pain associated with adhesion breakdown during and after massage.

Within this specification pathology is defined to include fibrous adhesions, trigger points, and tender points. Pathology is defined within this specification not to include bacterial or viral infections. Within this specification muscle is defined to include the fascia surrounding the muscle. Traumatized tissue could have resulted from either forces sustained in accidents, specific repeated motions in work, or even metabolic trauma such as psychological stress or systemic disease. Within this specification soft tissue 25 is defined to include muscle 24, tendons (not marked), and other soft tissue around joints. Fibrous adhesions 22 in traumatized tissue 25 may trigger pain continuously or only when palpated; the pain may either be local or in associated body regions.

FIGS. 2, 3, and 4, are partial elevational views of the right leg 34 shown in FIG. 1. In FIG. 2 the treated muscle 24 is in a contracted position. Sliding movement of pressure 34 along the length of the treated muscle 24 is just beginning. In FIG. 3, the treated muscle 24 is in an intermediate position. Sliding movement of the pressure 33 along the treated muscle 24 is also in an intermediate position. In FIG. 4 the treated muscle 24 is in a fully elongated or stretched position. The sliding movement of the pressure 33 along the treated muscle 24 has reached the end of the muscle 24. A lubricant 36 may be applied to the muscle 24 to minimize friction beneath the pressure 33 sliding therealong.

In one of the most preferred aspects of the invention, a movement along the length of the muscle 24 coincides with body motion (the right leg is shown moving in FIGS. 2, 3, and 4) moving the muscle 24 from a contracted to an elongated position so that the muscle is massaged in a repetitive cycle of body motion. In yet another aspect of the invention the muscle 24 is massaged slidingly along its length over an adhesion 22 therein when the muscle 24 is in an elongated or stretched position. Massage of the muscle 24 in an elongated or stretched position can be done alone, or alternatively before cyclical massage with body motion as described immediately above. In some cases it may be advisable to slidingly massage along the muscle 24 in an intermediate position before massaging in an elongated position and then massaging cyclically with body motion.

It is noted that the initial massage over the adhesions 22 in the treated muscle 24 frequently causes severe bruising in the first treatment. This is because there is an excessive capillary concentration adjacent to the fibrous adhesions 22 which were initially formed to supply oxygen and other nutrients for healing. By the third and fourth treatment bruising is minimal.

While the invention has been described with preferred specific embodiments thereof, it will be understood that this description is intended to illustrate and not to limit the scope of the invention, which is defined by the following claims.

I claim:

1) A method of normalizing an elongate traumatized soft tissue having pathology therein comprising the steps of:
locating the pathology in the traumatized tissue;
applying pressure on the traumatized tissue; and,
moving the pressure along the length of the traumatized tissue over the pathology therein to break down the pathology.

2) A method as in claim 1 wherein the traumatized tissue is a muscle having fibrous adhesions therein.

3) A method as in claim 2 wherein the pressure is slidingly moved along the muscle.

4) A method as in claim 3 wherein a lubricant is applied to the muscle to minimize friction beneath the pressure sliding therealong.

5) A method as in claim 3 wherein the movement along the length of the muscle coincides with a body motion moving the muscle from a contracted to an elongated position so that the muscle is massaged in a repetitive cycle of body motion.

6) A method as in claim 5 wherein the muscle is massaged slidingly along its length over an adhesion therein when the muscle is in an elongated position, before it is massaged with body motion.

7) A method as in 6 wherein the muscle is first massaged slidingly along its length over an adhesion therein, when the muscle is in an intermediate position between being fully contracted and fully elongated.

8) A method as in claim 3 wherein the muscle is generally positioned in a fully elongated position.

9) A method of normalizing an elongate traumatized soft tissue having pathology therein comprising the steps of:
locating the pathology in the traumatized tissue;
injecting an anesthetic into the pathology to promote, and relieve pain associated with the pathology breakdown;
applying pressure on the traumatized tissue; and,
moving the pressure along the length of the traumatized tissue over the pathology therein to break down the pathology.

10) A method as in claim 9 wherein the traumatized tissue is a muscle having fibrous adhesions therein.

11) A method as in claim 10 wherein the pressure is slidingly moved along the muscle.

12) A method as in claim 11 wherein a lubricant is applied to the muscle to minimize friction beneath the pressure sliding therealong.

13) A method as in claim 11 wherein a movement along the length of the muscle coincides with body motion moving the muscle from a contracted to an elongated position so that the muscle is massaged in a repetitive cycle of body motion.

14) A method as in claim 13 wherein the muscle is massaged slidingly along its length over an adhesion therein when the muscle is in an elongated position, before it is massaged with body motion.

15) A method as in 14 wherein the muscle is first massaged slidingly along its length over an adhesion therein, when the muscle is in an intermediate position between being fully contracted and fully elongated.

16) A method as in claim 11 wherein the muscle is generally placed in a fully elongated position.
